(19) United States
(12) Patent Application Publication
(10) Pub. No.: US 2023/0243453 A1
(43) Pub. Date: Aug. 3, 2023

(54) METHOD OF CONTROLLING HOSES AND PIPES UNDER PRESSURE

(71) Applicant: Maxinus Inc., Leduc (CA)

(72) Inventor: Michael UHRYN, Leduc (CA)

(21) Appl. No.: 18/163,444

(22) Filed: Feb. 2, 2023

(30) Foreign Application Priority Data
Feb. 3, 2022 (CA) 3 147 569

(51) Int. Cl. F16L 55/00

(52) U.S. Cl. CPC F16L 55/005

(57) ABSTRACT

A method of controlling hoses and pipes is provided. A hose or pipe has at least three segments that are connected together to create joints. The segments are connected such that fluid channels of the segments are in fluid communication with each other. An elongate tether is positioned across each of the joints. Each of the elongate tethers is attached to one of the segments adjacent the joint and the adjacent segment adjacent the joint. A zipper line is provided to add additional control. The zipper line has a first end connected to a first anchoring structure and a second end connected to a second anchoring structure. The zipper line is attachable to each of the elongate tethers attached to the at least three segments.

### FIELD OF THE DISCLOSURE

The present application relates generally to a method of controlling hoses and pies that become disconnected under pressure, more specifically it relates to a method of whip-checking.

### BACKGROUND

This section provides background information to facilitate a better understanding of the various aspects of the invention. It should be understood that the statements in this section of this document are to be read in this light, and not as admissions of prior art.

When pipes and hoses are under pressure, an unintentional disconnect can have devastating consequences. There is a tendency for these hoes and pipes to whip around uncontrollably as pressure is released from them after a disconnect. A whipping hose or pipe can cause damage to personnel and equipment. Limiting movement of a disconnected hose or pipe may help to create a safer workplace for personnel and limit damage to nearby equipment.

### BRIEF SUMMARY

There is provided a method of controlling hoses and pipes. A hose or pipe is provided that has at least three segments. Each of the at least three segments has a pair of connection ends and a hollow body having a fluid channel. The at least three segments are attached by the pair of connection ends to create a joint such that the fluid channels of each of the at least three segments are in fluid communication. An elongate tether is positioned across each joint. Each of the elongate tethers has a first end and a second end. The first end of the elongate tether is attached to one of the segments adjacent the joint and the second end of the elongate tether is attached to an adjacent segment adjacent the joint. A zipper line is provided. The zipper line has a first end connected to a first anchoring structure and a second end connected to a second anchoring structure. The zipper line is attachable to each of the elongate tethers attached to the at least three segments.

In one embodiment, the zipper line is attached to each of the elongate tethers by carabiners.

In one embodiment, the zipper line is made up of at least two zipper segments.

In one embodiment, the at least two zipper line segments may be connected together in an end to end relation.

In another embodiment, the at least two zipper line segments have a first end connected to one of the elongate tethers and a second end connected to either the first anchoring structure, the second anchoring structure, or a different elongate tether positioned on the hose or pipe.

In one embodiment, the first end of each of the elongate tethers and the second end of each of the elongate tethers are positioned equidistant from the joint which the elongate tether crosses.

In one embodiment, the first end of each of the elongate tethers has a first loop.

In one embodiment, the first end of the elongate tether is attached to the hose or pipe by passing the second end of the elongate tether through the first loop to create a tightenable loop around the hose or pipe.

In one embodiment, the second end of the elongate tether has a second loop. The second loop may be an adjustable eye loop.

In one embodiment, the second loop is attached to the hose or pipe by wrapping the second loop around the hose or pipe and connecting the second loop back to the elongate tether.

In one embodiment, the zipper line is connected to the first anchoring structure and the second anchoring structure by a choke hitch or basket choke.

In one embodiment, at least one of the elongate tethers is connected to the first anchoring structure.

In one embodiment, at least one of the elongate tethers is connected to the first anchoring structure using a choke hitch or a basket choke.

In one embodiment, at least one of the elongate tethers is connected to the second anchoring structure.

In one embodiment at least one of the elongate tethers is connected to the second anchoring structure using a choke hitch or a basket choke.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a side elevation view of a zipper line and elongate tethers positioned on a hose or pipe.

FIG. 2 is a side elevation view of a zipper line having multiple segments.

FIG. 3 is a side elevation view of a method of anchoring the zipper line to an anchoring structure.

FIG. 4 is a side elevation view of an alternative method of anchoring the zipper line to an anchoring structure.

FIG. 5 is side elevation view of an elongated tether on a pipe.

FIG. 6 is a side elevation view of an elongated tether anchored to an anchoring structure using a choke hitch.

FIG. 7 is a side elevation view of an elongated tether anchored to an anchoring structure using a basket choke.

### DETAILED DESCRIPTION OF THE PREFERRED EMBODIMENTS

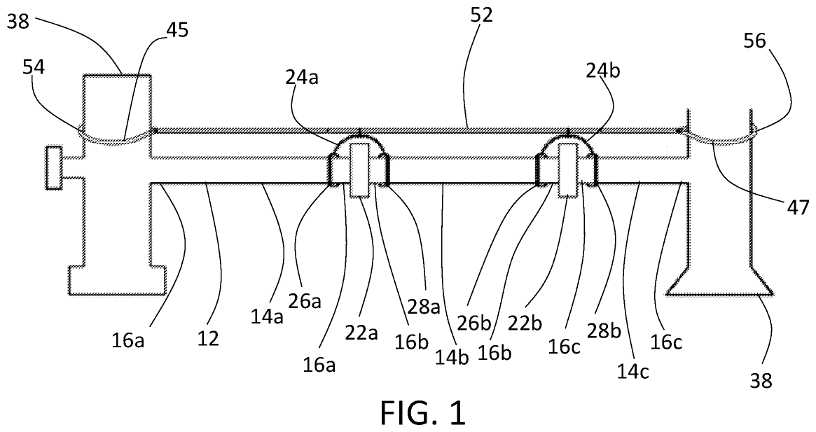

A method of controlling hoses and pipes under pressure will now be described with reference to FIG. 1 through FIG. 7.

Referring to FIG. 1, a hose or pipe 12 that is made up of at least three segments 14a, 14b, and 14c. In the embodiment shown in FIG. 1, three segments 14a, 14b, and 14c are illustrated, however it will be understood by a person skilled in the art that hose or pipe 12 may be made of any number of segments. The number of segments may be determined by the length and width of hose or pipe 12. Each segment 14a, 14b, and 14c, has a pair of connection ends 16a, 16b, and 16c, respectively. Segments 14a, 14b, and 14c are attached at connection ends 16a, 16b, and 16c to create joints 22a and 22b. When attached, segments 14a, 14b, and 14c are connected such that fluid channels 20a, 20b and 20c are in fluid communication with each other.

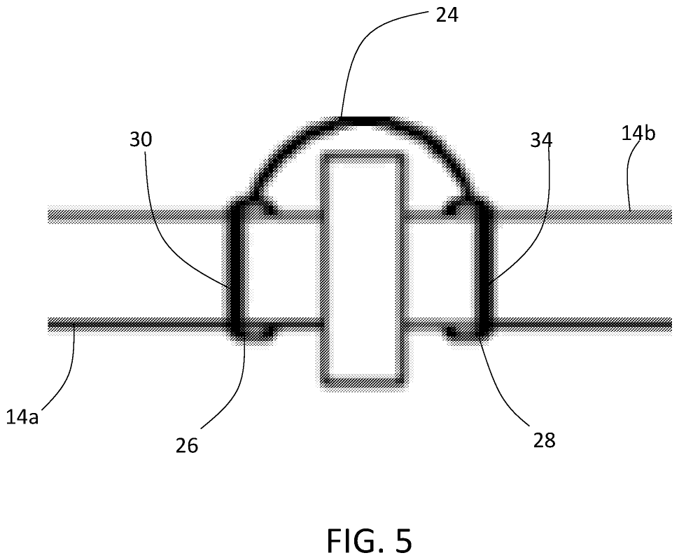

Referring to FIG. 5, an elongate tether 24 has a first end 26 and a second end 28. Elongate tether 24 may be a synthetic rope or may be made of any other suitable material known to a person skilled in the art. Elongate tether 24 should have a tensile strength that can withstand the forces applied to it in the event of a disconnect. It will be understood that the tensile strength required will be different depending upon the amount of pressure of fluid within hose or pipe 12. A person of skill will be able to calculate the tensile strength required based upon the amount of pressure of fluid within hose or pipe 12. Elongate tether 24 is relatively short in length with a preferred length of 30 to 64 inches. In one embodiment, elongate tether is 34.5 inches in length. Referring to FIG. 1, this short length helps to limit movement of segments 14a, 14b, and 14c of hose or pipe 12 away from each other. In addition, the short length provides greater strength to elongate tether 24. It will be understood by a person skilled in the art that different lengths of elongate tether 24 may be used.

Referring to FIG. 1, elongate tethers 24 are positioned across each joint 22a and 22b and act to hold adjacent segments 14a and 14b or 14b and 14c in close proximity to each other in the event of a disconnect. This helps to limit movement during a disconnect and help to reduce or prevent damage or injury due to the chaotic motion of disconnected segments. In the embodiment shown, first end 26a of elongate tether 24a is attached to one of the segments 14a adjacent joint 22a and second end 28a of elongate tether 24a is attached to adjacent segment 14b adjacent joint 22a. A second elongate tether 24b is positioned across joint 22b. First end 26b of elongate tether 24b is attached to one of the segments 14b adjacent joint 22b and second end 28b of elongate tether 24b is attached to adjacent segment 14c adjacent joint 22b.

Referring to FIG. 5, first end 26 of elongate tether 24 is attached to segment 14a of hose or pipe 12 adjacent joint 22a. In the embodiment shown, first end 26 forms a first loop 30. First end 26 is attached to hose or pipe 12 by passing second end 28 of elongated tether 24 through first loop 30, as shown in FIG. 4, to create loop 30 that is slid over connection end 16a and placed around hose or pipe 12. It will be understood by a person skilled in the art that first end 26 of elongate tether 24 may be attached in any other way known to a person skilled in the art. After first end 26 of elongate tether 24 is attached to hose or pipe 12, second end 28 of elongate tether 24 is attached to segment 14b of hose or pipe 12 adjacent joint 22a. In the embodiment shown, second end 28 is a second loop 34. Second end 28 may be attached to segment 14b of hose or pipe 12 by sliding second loop 34 over connection end 16b and placing it around hose or pipe 12. In the embodiment shown, second loop 34 is an adjustable eye loop that can be tightened or loosening by sliding elongate tether 24 through a binding, not shown. It will be understood by a person skilled in the art that second loop 34 may be adjusted in any other fashion known to a person skilled in the art. Other methods of attaching first loop 30 and second loop 34 will be known to persons skilled in the art. As an example only, second end 28 is attached to segment 14b of hose or pipe 12 by wrapping second loop 34 around hose or pipe 12 and connecting second loop 34 back to elongate tether 24. This effectively creates a loop around hose or pipe 12. Connecting second loop 34 back to elongate tether 24 may be done using a carabiner, a tie or any other type of connector known to a person skilled in the art. It will be understood by a person skilled in the art that second end 28 of elongate tether 24 may be attached in any other way known to a person skilled in the art. Second end 28 is tightened around hose or pipe 12.

To help limit movement of segments 14a, 14b, and 14c of hose or pipe 12 away from each other, slack is removed from elongate tether 24 after connection between adjacent segments of hose are made. This is accomplished by loosening first loop 30 and/or second loop 34 and moving them away from each other. After slack has been removed, it is preferable that first loop 30 and second loop 34 be retightened around hose or pipe 12. In the embodiment shown, first end 26 and second end 28 of elongate tether 24 are positioned substantially equidistant from joint 22a which is created when segments 14a and 14b are connected together.

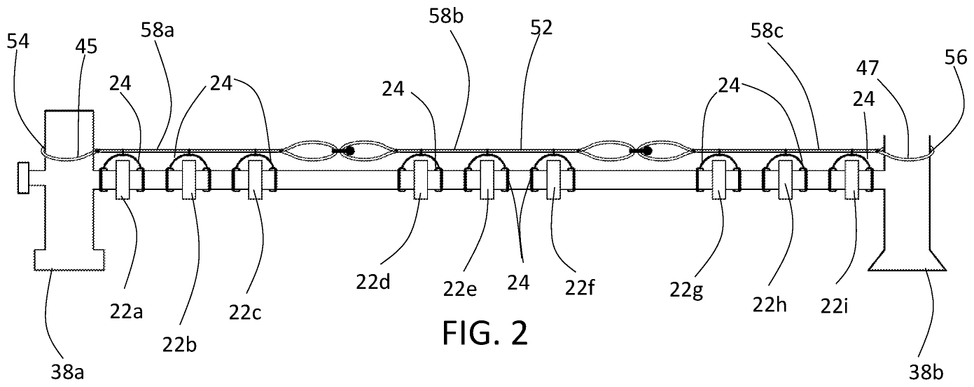

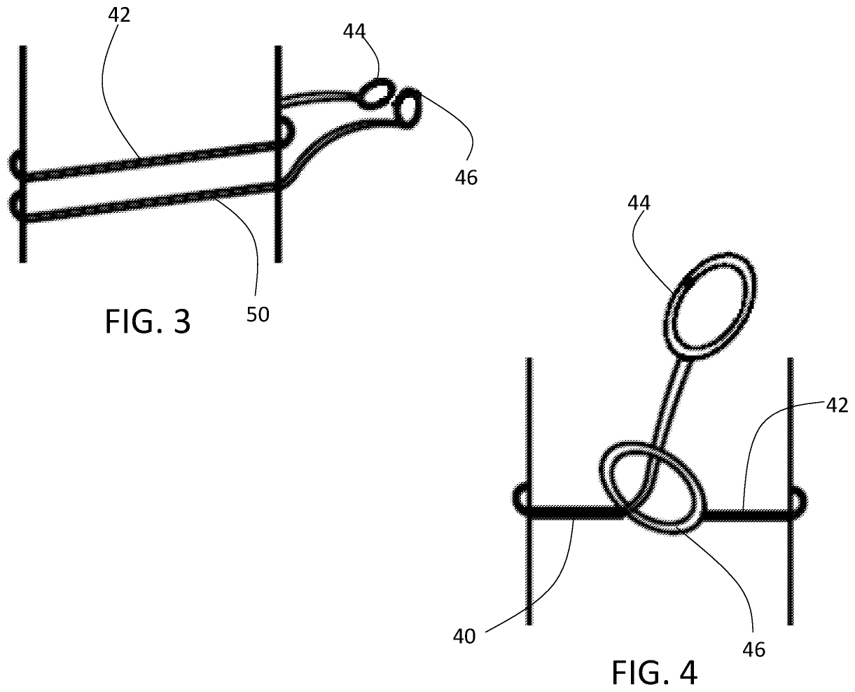

Referring to FIG. 1, a zipper line 52 is provided to create redundancy in control measures. Zipper line 52 has a first end 54 connected to a first anchoring structure 38a and a second end 56 connected to a second anchoring structure 38b. In the embodiment shown in FIG. 3, zipper line 52 is anchored using a basket choke 50. In the embodiment shown, basket choke 50 is created using a second elongate tether or zipper line 42 that has a first loop 44 and a second loop 46. Second elongate tether or zipper line 42 is wrapped twice around anchoring structure 38. First loop 44 and second loop 46 are attached to zipper line 52 through the use of a connector, not shown. Connector may be a carabiner, or any other suitable connector known to a person skilled in the art. In the embodiment shown in FIG. 4, zipper line 52 is anchored using a choke hitch 40. In the embodiment shown, choke hitch 40 is created using a second elongate tether or zipper line 42 that has a first loop 44 and a second loop 46. Second elongate tether or zipper line 42 is wrapped around anchoring structure 36 and first loop 44 is passed through second loop 46 to create choke hitch 40. First loop 44 of second elongate tether 42 is attached to elongate tether 24 through the use of a connector, not shown. Connector may be a carabiner, or any other suitable connector known to a person skilled in the art. In the embodiment shown in FIG. 1 and FIG. 2, first end 54 and second end 56 have loops 45 and 47 that are connected to first anchoring structure 38a and second anchoring structure 38b. Simple loops 45 and 47 may be used where anchoring structures 38a and 38b allow for this simple type of attachment, however in most cases it is more practical to use a basket choke or choke hitch.

Referring to FIG. 1, zipper line 52 is attachable to each elongate tether 24a and 24b attached to segments 14a, 14b, and 14c of hose or pipe 12. Zipper line 52 may be attached to each elongate tether 24 by carabiner, tie, knot, or any other suitable mechanism known to a person skilled in the art. It will be understood that zipper line 52 may be positioned above or below pipe 12. In the embodiment shown in FIG. 1, zipper line 52 may be a single line extending the entire distance between first anchoring structure 38a and second anchoring structure 38b. In the embodiment shown in FIG. 2, zipper line is made up of three zipper line segments 58a, 58b, and 58c. It will be understood by a person skilled in the art that any number of segments may be used. Using shorter zipper line segments can allow zipper line 52 to be tauter, which results in greater control during the disconnect of segments of hose or pipe 12.

In the embodiment shown in FIG. 2, zipper line segments 58a, 58b, and 58c may be connected in end to end relation to create a continuous zipper line 52 using carabiners, clevis, or any other method known to a person skilled in the art. Zipper line segment 58a is attached to first anchoring structure 38a and zipper line segment 58b. Zipper line segment 58b is attached to zipper line segments 58a and 58c. Zipper line segment 58c is attached to zipper line segment 58b and second anchoring structure 38b. Zipper line segment 58a is connected to elongate tethers 24 positioned across joints 22a, 22b, and 22c. Zipper line segment 58b is connected to elongate tethers 24 positioned across joints 22d, 22e, and 22f and zipper line segment 58c is connected to elongate tethers 24 positioned across joints 22g, 22h, and 22i.

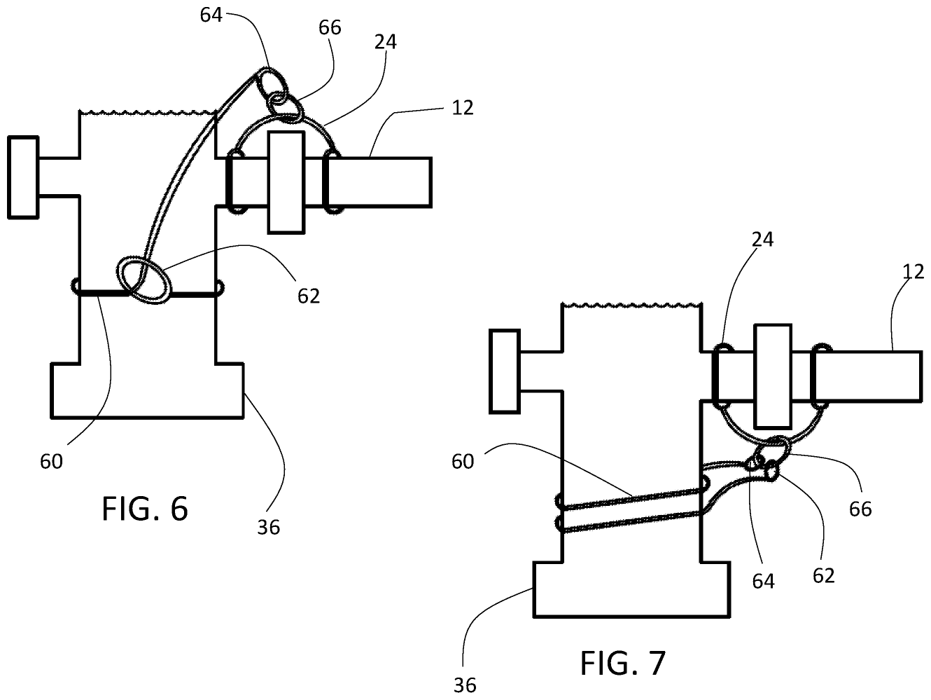

In addition to anchoring zipper line 52 to anchoring structures 38a and 38b, at least one of elongate tethers 24 may also be anchored to anchoring structures 38a or 38b. Elongate tethers 24 may also be attached to each other to provide additional control in the event of a hose or pipe disconnect. In the embodiment shown in FIG. 6, elongate tether 24 is anchored using a choke hitch. In the embodiment shown, choke hitch is created using a second elongate tether 60 that has a first loop 62 and a second loop 64. Second elongate tether 60 is wrapped around anchoring structure 36 and first loop 62 is passed through second loop 64 to create choke hitch. First loop 62 of second elongate tether 60 is attached to elongate tether 24 through the use of a connector 66. Connector 66 may be a carabiner, or any other suitable connector known to a person skilled in the art. In the embodiment shown in FIG. 7, elongate tether 24 is anchored using a basket choke. In the embodiment shown, basket choke is created using a second elongate tether 60 that has a first loop 62 and a second loop 64. Second elongate tether 60 is wrapped twice around anchoring structure 38. First loop 62 and second loop 64 are attached to elongate tether 24 through the use of a connector 66. Connector 66 may be a carabiner, or any other suitable connector known to a person skilled in the art.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A method of controlling hoses and pipes comprising the steps of:
providing a hose or pipe having at least three segments, the at least three segments each having a pair of connection ends and a hollow body having a fluid channel, the at least three segments being attached by the pair of connection ends to create a joint such that the fluid channels of each of the at least three segments are in fluid communication;
positioning an elongate tether across each of the joints, each of the elongate tethers having a first end and a second end, the first end of the elongate tether being attached to one of the segments adjacent the joint and the second end of the elongate tether being attached to an adjacent segment adjacent the joint; and
providing a zipper line, the zipper line having a first end connected to a first anchoring structure and a second end connected to a second anchoring structure, the zipper line being attachable to each of the elongate tethers attached to the at least three segments.

2. The method of claim 1 wherein the zipper line is attached to each of the elongate tethers by carabiners.

3. The method of claim 1 wherein the zipper line is made up of at least two zipper line segments.

4. The method of claim 3 wherein the at least two zipper line segments are connected together in an end to end relation.

5. The method of claim 4 wherein the at least two zipper line segments have a first end connected to one of the elongate tethers and a second end connected to either the first anchoring structure, the second anchoring structure or a different elongate tether positioned on the hose or pipe.

6. The method of claim 1 wherein the first end of each of the elongate tethers and the second end of each of the elongate tethers are positioned equidistant from the joint which the elongate tether crosses.

7. The method of claim 1 wherein the first end of each of the elongate tethers has a first loop.

8. The method of claim 7 wherein the first end of the elongate tether is attached to the hose or pipe by passing the second end of the elongate tether through the first loop to create a tightenable loop around the hose or pipe.

9. The method of claim 1 wherein the second end of the elongate tether has a second loop.

10. The method of claim 9 wherein the second loop is an adjustable eye loop.

11. The method of claim 9 wherein the second loop is attached to the hose or pipe by wrapping the second loop around the hose or pipe and connecting the second loop back to the elongate tether.

12. The method of claim 1 wherein the zipper line is connected to the first anchoring structure and the second anchoring structure by a choke hitch or a basket choke.

13. The method of claim 1 wherein at least one of the elongate tethers is connected to the first anchoring structure.

14. The method of claim 13 wherein at least one of the elongate tethers is connected to the first anchoring structure using a choke hitch or a basket choke.

15. The method of claim 1 wherein at least one of the elongate tethers is connected to the second anchoring structure.

16. The method of claim 15 wherein at least one of the elongate tethers is connected to the second anchoring structure using a choke hitch or a basket choke.
